(19) United States
(12) Patent Application Publication
(10) Pub. No.: US 2013/0340032 A1
(43) Pub. Date: Dec. 19, 2013

(54) SYSTEM AND METHOD FOR ACHIEVING COMPLIANCE THROUGH A CLOSED LOOP INTEGRATED COMPLIANCE FRAMEWORK AND TOOLKIT

(71) Applicant: Infosys Limited, Bangalore (IN)

(72) Inventors: MOHANAKRISHNAN SHANKAR, CHENNAI (IN); GIDEON PREMKUMAR MANOHARAN, CHENNAI (IN); AMIT SAHA, BANGALORE (IN)

(21) Appl. No.: 13/918,554

(22) Filed: Jun. 14, 2013

(30) Foreign Application Priority Data
Jun. 15, 2012 (IN) 2386/CHE/2012

(51) Int. Cl. H04L 29/06

(52) U.S. Cl. CPC H04L 63/20
USPC 726/1

(57) ABSTRACT

The disclosed embodiments relate to a method, apparatus, and computer-readable medium for managing policy compliance. As exemplary method comprises receiving, by at least one of the one or more computing devices, information associated with a policy event corresponding to a system resource; determining, by at least one of the one or more computing devices, whether the policy event is in compliance with one or more policies; determining, by at least one of the one or more computing devices, a corrective action if the policy event is not in compliance with at least one of the one or more policies; and transmitting, by at least one of the one or more computing devices, information associated with the corrective action if the policy event is not in compliance with at least one of the one or more policies.

### RELATED APPLICATION DATA

This application claims priority to India Patent Application No. 2386/CHE/2012, filed Jun. 15, 2012, the disclosure of which is hereby incorporated by reference in its entirety.

### FIELD OF THE INVENTION

The invention relates to a method and apparatus for managing policy compliance.

### SUMMARY

The disclosed embodiment relates to a computer-implemented method executed by one or more computing devices for managing policy compliance. As exemplary method comprises receiving, by at least one of the one or more computing devices, information associated with a policy event corresponding to a system resource, determining, by at least one of the one or more computing devices, whether the policy event is in compliance with one or more policies, determining, by at least one of the one or more computing devices, a corrective action if the policy event is not in compliance with at least one of the one or more policies, and transmitting, by at least one of the one or more computing devices, information associated with the corrective action if the policy event is not in compliance with at least one of the one or more policies.

The disclosed embodiment further relates to an apparatus for managing policy compliance. An exemplary apparatus comprises one or more processors, and one or more memories operatively coupled to at least one of the one or more processors and storing instructions that, when executed by at least one of the one or more processors, cause at least one of the one or more processors to receive information associated with a policy event corresponding to a system resource, determine whether the policy event is in compliance with one or more policies, determine a corrective action if the policy event is not in compliance with at least one of the one or more policies, and transmit information associated with the corrective action if the policy event is not in compliance with at least one of the one or more policies.

In addition, the disclosed embodiment relates to at least one non-transitory computer-readable medium storing computer-readable instructions that, when executed by one or more computing devices, managing policy compliance, the instructions causing at least one of the one or more computing devices to receive information associated with a policy event corresponding to a system resource, determine whether the policy event is in compliance with one or more policies, determine a corrective action if the policy event is not in compliance with at least one of the one or more policies, and transmit information associated with the corrective action if the policy event is not in compliance with at least one of the one or more policies.

Further, according to the disclosed embodiment, the policy event may be related to an attempt to access the system resource, the system resource may be remotely located, the policy event may be associated with a user, the corrective action may include providing information related to the policy event, and the corrective action may include providing information corresponding to actions that can be taken to correct the policy event to cause the policy event to be in compliance with the one or more policies.

### BRIEF DESCRIPTION OF THE DRAWINGS

FIG. 1 illustrates an exemplary system according to the disclosed embodiment.

FIG. 2 illustrates an exemplary method according to the disclosed embodiment.

FIG. 3 illustrates an exemplary computing device according to the disclosed embodiment.

### DETAILED DESCRIPTION

The disclosed embodiment relates to information technology (IT) related security control compliance management in an enterprise. The term “control” as used herein refers to one or both of IT controls and security controls. More specifically, the disclosed embodiment relates to a tool to assess an organization's preparedness and effectiveness of their internal IT controls to achieve compliance with various industry regulations. The disclosed embodiment provides a framework of controls that are applicable to the organization and based on the applicable controls an assessment has to be carried out. The tool kit will serve as a resource for any Information Security Consultant or Auditor in carrying out compliance assessments and come up with the compliance score for an organization. The tool will enable having a complete integrated compliance controls solution with in an enterprise known as closed loop integrated compliance by which controls are integrated with in an enterprise for fully automated and controlled compliance management.

Thus, the disclosed embodiment provides a compliance controls framework which will help in integrated approach for managing compliance in an enterprise. The solution helps in integrating various security compliance management across the enterprise to provide solution so as to have effective management of IT compliance, reducing the manual effort that is spent today to implement governance, risk and compliance (GRC) policies/processes and reduce the cost of GRC roll out and associated information security audits. The disclosed embodiment preferably facilitates automation of significant portions of the routine tasks of GRC and provides seamless compliance management.

Existing GRC products have disadvantages that can be overcome by the tools of the disclosed embodiment. For example, existing GRC products do not effectively cover all global regulatory requirements. In addition, the control requirements mapping framework across different regulations are in inconsistent in different tools, the products available currently don't allow flexible configuration to select only applicable controls for an organization's specific business processes, and current efforts of technology in enterprises are silo based and do not look at integrated compliance controls, thereby making GRC product and solution implementation in an enterprise also a complex activity.

To overcome some of the limitations of existing technologies, the disclosed embodiment utilizes a framework called “closed loop compliance” which integrates the technology controls in an enterprise to provide a “fully aware and integrated system.” The disclosed embodiment further automates compliance activities, correlates common compliance controls, corrects identified gaps, effectively plans and optimizes of compliance controls, reduces cycle time of audits, and the like.

More specifically, the disclosed embodiment identifies commonalities between compliance standards, reduces compliance program costs by going through a comprehensive compliance tool kit, automates controls design, operation and maintenance, correlates new compliance standards as they are recognized and implemented, conducts ongoing audit management, automates compliance management at a system level instead of just at a process or policy level, and the like.

In addition, by using the tools of the disclosed embodiment, compliance controls assessment and management can be automated, common controls framework can be used that are not required to look into each compliance standard specifically, controls and regulations can be selectively applied for assessment based on need, and the like.

While providing the above-described utilities, the disclosed embodiment can be utilized in enterprises seeking to overcome problems associated with managing compliance control, which can be very expensive and labor intensive.

Organizations are embarking on compliance journey based on specific compliance requirements using expensive solutions. Instead if common controls based approach is taken along with a solution which is easy to use and costs less it can effectively reduce the compliance cost, reduce human intervention and cycle time.

Today various enterprise technology systems such as a Human Resources Management System (HRMS), the billing system, Finance systems etc. constitute the enterprise IT building block. All these systems are subject to various regulatory compliance requirements where organizations are required to implement a solution to secure information in line with the regulatory requirement of various compliance standards. The solution implemented includes some native capabilities such as credential management with in the system such as say HRMS, or alternatively have enterprise security solutions such as Identity & access management system, Security incident and event monitoring systems, data and application security access control systems and so on and so forth. One of the major challenge with these systems are that the only look at individual vulnerability of the respective technologies and do not try to have an integrated view with other security systems to provide a holistic picture on the current state of controls compliance and its remediation.

Adhering to the various industry compliance regulations and standards requires organization IT security and controls offices to define controls, work with business and IT stakeholders to implement the controls in the respective systems, periodically test and monitor the controls, have an audit done internally and externally to review these control effectiveness and how they are operating and generate reports for both internal consumption within the organization and for audit reporting purposes.

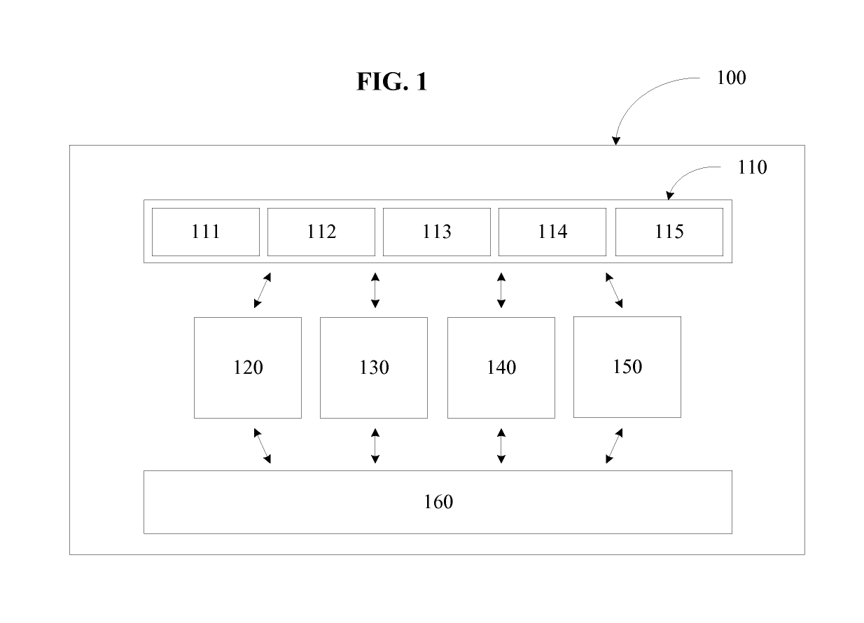

FIG. 1 illustrates a logical block of an exemplary closed loop integrated compliance system 100. Referring to FIG. 1, a closed loop integrated compliance engine 110 manages the system's compliance in an effective way. The compliance engine preferably includes a controls toolkit knowledge base 111, a controls integrator 112, an automation engine 113, a policies repository 114, a remediation and reporting engine 115, and the like.

Controls toolkit knowledge base 111 includes the knowledge base of the master list of controls within an organization. The solution also has a master list of controls which are required by majority of the Industry regulatory compliance standards and has common mapping between the controls, so that it can serve as controls body of knowledge which can be referenced to ensure compliance is met or not.

Controls integrator 112 is responsible for creating a common set of connectors so that information on controls can be obtained from various IT controls systems such as Identity and access management system, security incident and event management system, etc.

Automation engine 113 is responsible for ongoing automation of compliance checks on a continuous basis while working in tandem with above mentioned blocks and will have capability to do automation of compliance testing for specific control based on from a controls toolkit knowledgebase for a specific target enterprise technology system.

Policies repository 114 stores the various compliance, IT security and policies with in an enterprise.

Remediation and reporting engine 115 is responsible for making a fix based on the policies, controls toolkit knowledge and integrator for making a control meet with compliance mandates to the extent possible within the boundaries of the system. The reporting engine is responsible for providing reports on compliance across target enterprise technology system or compliance standard.

Using these components, compliance engine 110 communicates with enterprise technology systems 160 and assists with identity and access management technologies 120, application data security technologies 130, controlling monitoring technologies 140, and information security technologies 150, and the like.

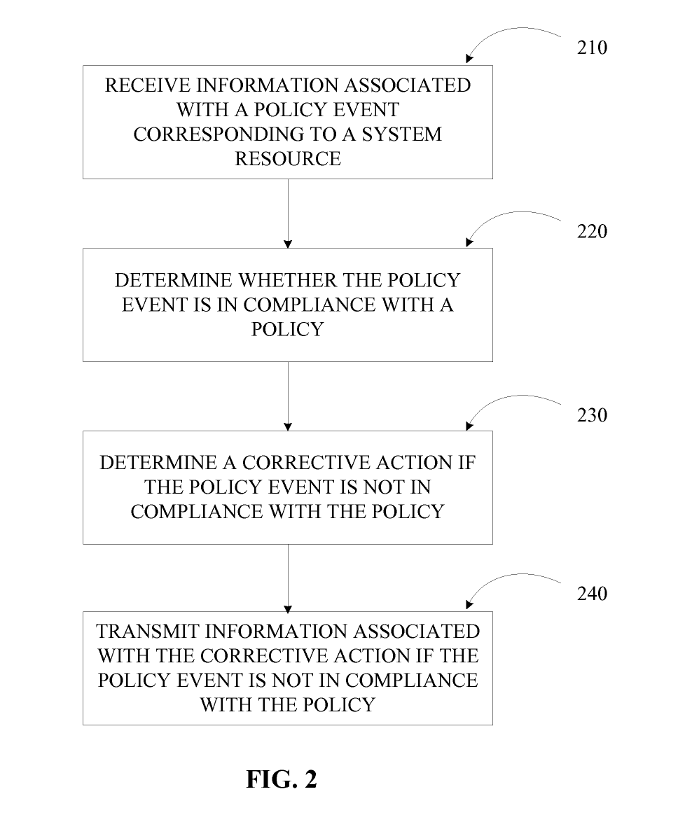

FIG. 2 illustrates an exemplary method according to the disclosed embodiment. In step 210, information associated with a policy event corresponding to a system resource is received. In step 220, it is determined whether the policy event is in compliance with one or more policies. In step 230, a corrective action is determined if the policy event is not in compliance with at least one of the one or more policies. Then, in step 240, information associated with the corrective action is transmitted if the policy event is not in compliance with at least one of the one or more policies. Further, according to the disclosed embodiment, the policy event may be related to an attempt to access the system resource, the system resource may be remotely located, the policy event may be associated with a user, the corrective action may include providing information related to the policy event, and the corrective action may include providing information corresponding to actions that can be taken to correct the policy event to cause the policy event to be in compliance with the one or more policies.

For example, suppose a user: “A” who is present in physical location “W” and has account in a HRMS System Module in location “W”. However if he tries to log into a system Module in location “Y” for which he does not have access to. Assume he has been able to log in to the module of location “Y” through some system compromise or vulnerabilities. Now a Security incident and event management system will have this information logged. The identity and access management system will also have it in its logs of this event. Now the major problem in identifying and correcting these kinds of incidents on the fly and also to make compliance adherence is a challenge and is mostly done through manual mechanism in a very ineffective way.

Now suppose the same scenario with the closed loop integrated compliance engine of the disclosed embodiment implemented. With a close loop compliance engine, because the identity access management system and the security incident and event management system are integrated, the automation engine, which is continuously testing the systems for compliance checks, can identify this incident and report that the event does not meet. With the inference from this continuous testing, the remediation engine can act based on this policy, for example, to disable all system access for User “A”. Other possible actions include triggering an email to a manager or other concerned IT stakeholders in the system, triggering a workflow where by User “A” is able to provide a reasoning for this incident and if has been approved by his manager could actually request for access, and the like. All of these options mentioned are automated by the closed loop integrated compliance engine in an automated fashion while not compromising on compliance to the various compliance and controls requirement.

The above mentioned is just a one use case to demonstrate the closed loop integrated compliance engine. This could be extended to complete set of IT controls automation and management for meeting compliance needs in an enterprise.

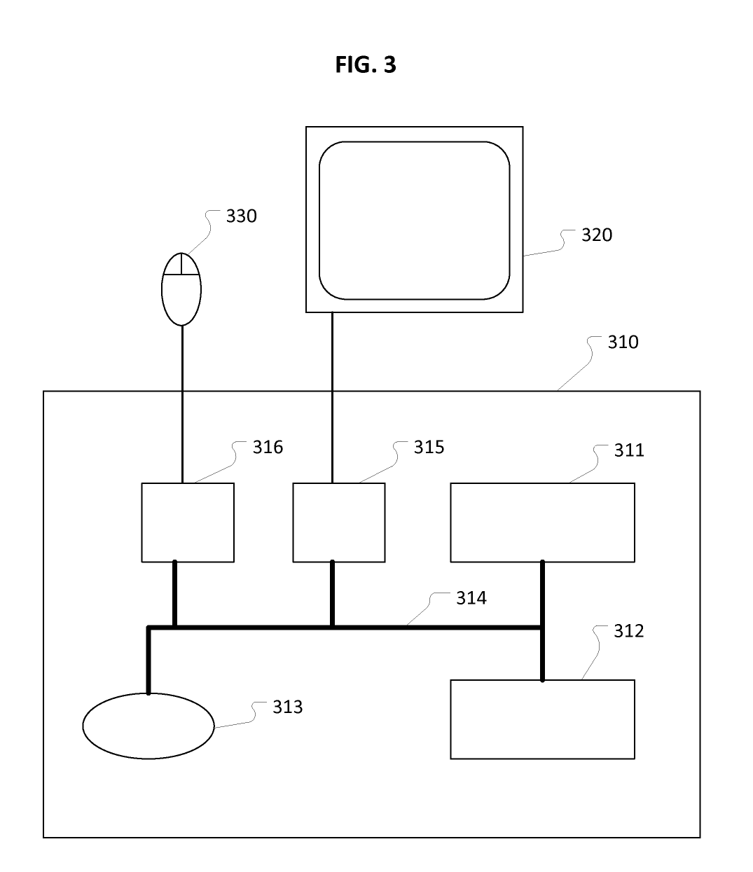

The embodiments described herein may be implemented with any suitable hardware and/or software configuration, including, for example, modules executed on computing devices such as computing device 310 of FIG. 3. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 310 has one or more processing device 311 designed to process instructions, for example computer readable instructions (i.e., code) stored on a storage device 313. By processing instructions, processing device 311 may perform the steps set forth in the methods described herein. Storage device 313 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 310 additionally has memory 312, an input controller 316, and an output controller 315. A bus 314 operatively couples components of computing device 310, including processor 311, memory 312, storage device 313, input controller 316, output controller 315, and any other devices (e.g., network controllers, sound controllers, etc.). Output controller 315 may be operatively coupled (e.g., via a wired or wireless connection) to a display device 320 (e.g., a monitor, television, mobile device screen, touch-display, etc.) In such a fashion that output controller 315 can transform the display on display device 320 (e.g., in response to modules executed). Input controller 316 may be operatively coupled (e.g., via a wired or wireless connection) to input device 330 (e.g., mouse, keyboard, touch-pad, scroll-ball, touch-display, etc.) In such a fashion that input can be received from a user (e.g., a user may input with an input device 330 a dig ticket).

Of course, FIG. 3 illustrates computing device 310, display device 320, and input device 330 as separate devices for ease of identification only. Computing device 310, display device 320, and input device 330 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 310 may be one or more servers, for example a farm of networked servers, a clustered server environment, or a cloud network of computing devices.

While systems and methods are described herein by way of example and embodiments, those skilled in the art recognize that the disclosed embodiment is not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A computer-implemented method executed by one or more computing devices for managing policy compliance, the method comprising:
receiving, by at least one of the one or more computing devices, information associated with a policy event corresponding to a system resource;
determining, by at least one of the one or more computing devices, whether the policy event is in compliance with one or more policies;
determining, by at least one of the one or more computing devices, a corrective action if the policy event is not in compliance with at least one of the one or more policies; and
transmitting, by at least one of the one or more computing devices, information associated with the corrective action if the policy event is not in compliance with at least one of the one or more policies.

2. The method of claim 1, wherein the policy event is related to attempt to access the system resource.

3. The method of claim 1, wherein the system resource is remote from the one or more computing devices executing the method.

4. The method of claim 1, wherein the policy event is associated with a user.

5. The method of claim 1, wherein the corrective action includes providing information related to the policy event.

6. The method of claim 1, wherein the corrective action includes providing information corresponding to actions that can be taken to correct the policy event to cause the policy event to be in compliance with the one or more policies.

7. An apparatus for managing policy compliance, the apparatus comprising:
one or more processors; and
one or more memories operatively coupled to at least one of the one or more processors and storing instructions that, when executed by at least one of the one or more processors, cause at least one of the one or more processors to:
receive information associated with a policy event corresponding to a system resource;
determine whether the policy event is in compliance with one or more policies;
determine a corrective action if the policy event is not in compliance with at least one of the one or more policies; and
transmit information associated with the corrective action if the policy event is not in compliance with at least one of the one or more policies.

8. The apparatus of claim 7, wherein the policy event is related to attempt to access the system resource.

9. The apparatus of claim 7, wherein the system resource is remote from the one or more processors executing the instructions.

10. The apparatus of claim 7, wherein the policy event is associated with a user.

11. The apparatus of claim 7, wherein the corrective action includes providing information related to the policy event.

12. The apparatus of claim 7, wherein the corrective action includes providing information corresponding to actions that can be taken to correct the policy event to cause the policy event to be in compliance with the one or more policies.

13. At least one non-transitory computer-readable medium storing computer-readable instructions that, when executed by one or more computing devices, managing policy compliance, the instructions causing at least one of the one or more computing devices to:
receive information associated with a policy event corresponding to a system resource;
determine whether the policy event is in compliance with one or more policies;
determine a corrective action if the policy event is not in compliance with at least one of the one or more policies; and
transmit information associated with the corrective action if the policy event is not in compliance with at least one of the one or more policies.

14. The at least one non-transitory computer-readable medium of claim 13, wherein the policy event is related to attempt to access the system resource.

15. The at least one non-transitory computer-readable medium of claim 13, wherein the system resource is remote from the one or more computing devices executing the instructions.

16. The at least one non-transitory computer-readable medium of claim 13, wherein the policy event is associated with a user.

17. The at least one non-transitory computer-readable medium of claim 13, wherein the corrective action includes providing information related to the policy event.

18. The at least one non-transitory computer-readable medium of claim 13, wherein the corrective action includes providing information corresponding to actions that can be taken to correct the policy event to cause the policy event to be in compliance with the one or more policies.
